(19) United States
(12) Patent Application Publication
(10) Pub. No.: US 2019/0260612 A1
(43) Pub. Date: Aug. 22, 2019

(54) METHOD FOR TRANSMITTING SOUNDING REFERENCE SIGNAL, NETWORK DEVICE, AND TERMINAL DEVICE

(71) Applicant: Huawei Technologies Co., Ltd., Shenzhen (CN)

(72) Inventor: Chuanfeng HE, Shenzhen (CN)

(21) Appl. No.: 16/404,322

(22) Filed: May 6, 2019

Related U.S. Application Data
(63) Continuation of application No. PCT/CN2016/104782, filed on Nov. 4, 2016.

(51) Int. Cl. H04L 25/02; H04L 5/00; H04W 72/04; H04L 5/14; H04L 27/26

(52) U.S. Cl. CPC H04L 25/0226; H04L 5/0051; H04L 27/2605; H04L 5/1469; H04L 27/2613; H04W 72/0446

(57) ABSTRACT

Embodiments of this application provide a method for transmitting a sounding reference signal, a network device, and a terminal device, to avoid frequent carrier switching, so that carrier switching overheads can be reduced. The method includes: sending, by a network device, an instruction message to a terminal device, where the instruction message is used to instruct the terminal device to send a sounding reference signal (SRS) on a second symbol in first symbols, the first symbols are symbols in uplink pilot slots (UpPTSs) of two special subframes in a radio frame, and the second symbol is a symbol in an UpPTS of at least one of the two special subframes; and receiving, by the network device on the second symbol, the SRS sent by the terminal device.

### CROSS-REFERENCE TO RELATED APPLICATION

This application is a continuation of International Application No. PCT/CN2016/104782, filed on Nov. 4, 2016, the disclosure of which is hereby incorporated by reference in its entirety.

### TECHNICAL FIELD

Embodiments of this application relate to the communications field, and in particular, to a method for transmitting a sounding reference signal, a terminal device, and a network device in the communications field.

### BACKGROUND

In a Long Term Evolution (LTE) system, a base station needs a terminal device to send a sounding reference signal (SRS), so that the base station can estimate uplink channel information based on the SRS, and further correctly schedule the terminal device.

In an SRS transmission process, symbol overheads are required, and how to reduce symbol overheads in SRS transmission needs to be studied.

### SUMMARY

Embodiments of this application provide a method for transmitting a sounding reference signal (SRS), a network device, and a terminal device, to reduce symbol overheads during SRS transmission.

According to a first aspect, an embodiment of this application provides a method for transmitting a sounding reference signal (SRS), including:

sending, by a network device, an instruction message to a terminal device, where the instruction message is used to instruct the terminal device to send an SRS on a second symbol in first symbols, the first symbols are symbols in uplink pilot slots (UpPTSs) of two special subframes in a radio frame, and the second symbol is a symbol in an UpPTS of at least one of the two special subframes; and

receiving, by the network device on the second symbol, the SRS sent by the terminal device.

Therefore, in this embodiment of this application, the network device sends the instruction message to the terminal device, to instruct the terminal device to send the SRS on a symbol in an UpPTS of at least one of the two special subframes in the radio frame, so that symbol overheads during SRS transmission can be significantly reduced.

Optionally, in an implementation of the first aspect, the network device sends the instruction message to the terminal device over a first carrier, and the first carrier is further used to transmit uplink data.

Therefore, the terminal device is instructed to send the SRS on the symbol in the UpPTS of the at least one of the two special subframes in the radio frame, so as to avoid frequent carrier switching, and reduce carrier switching overheads.

Optionally, in an implementation of the first aspect, the symbol used to send the SRS may be a single carrier frequency division multiple access (SC-FDMA) symbol or a downlink symbol that is referred to as an orthogonal frequency division multiple access (OFDMA) symbol.

Optionally, in an implementation of the first aspect, the network device sends at least two SRS configurations to the terminal device, the at least two SRS configurations include at least two SRS configuration indexes I_{SRS}, and the at least two I_{SRS} are corresponding to the first symbols.

Optionally, in an implementation of the first aspect, the symbols in the UpPTSs include two symbol sets, and there is no intersection between the two symbol sets.

The at least two SRS configurations are used to indicate symbols in at least one of the two symbol sets; and the I_{SRS} is used to indicate an SRS subframe offset and an SRS period, and used to determine the symbols in the symbol set.

Optionally, in an implementation of the first aspect, the at least two SRS configurations include a first SRS configuration, a second SRS configuration, and a third SRS configuration. The first SRS configuration includes a first I_{SRS}, the second SRS configuration includes a second I_{SRS}, and the third SRS configuration includes a third I_{SRS}.

The first I_{SRS} is corresponding to a symbol in a first symbol set of the at least two symbol sets.

The second I_{SRS} and the third I_{SRS} are separately corresponding to symbols in a second symbol set of the at least two symbol sets, where a symbol corresponding to the second I_{SRS} is different from a symbol corresponding to the third I_{SRS}.

Optionally, in an implementation of the first aspect, there is a symbol spacing between any two symbol sets in the at least two symbol sets.

Optionally, in an implementation of the first aspect, the at least two SRS configurations include a fourth SRS configuration and a fifth SRS configuration. The fourth SRS configuration includes a fourth I_{SRS}, and the fifth SRS configuration includes a fifth I_{SRS}.

The fourth I_{SRS} is corresponding to a symbol in a first symbol set of the at least two symbol sets.

The fifth I_{SRS} is corresponding to a symbol in a second symbol set of the at least two symbol sets.

Optionally, in an implementation of the first aspect, the fifth I_{SRS} is corresponding to four subframe offsets, and the four subframe offsets are corresponding to four symbols in the second symbol set.

Optionally, in an implementation of the first aspect, an SRS trigger type corresponding to the at least two SRS configurations is a first trigger type or a second trigger type.

When the SRS trigger type corresponding to the at least two SRS configurations is the first trigger type, the at least two SRS configurations and the instruction message are used to instruct the terminal device to send the SRS on the second symbol; or

when the SRS type corresponding to the at least two SRS configurations is the second trigger type, the method further includes: sending an SRS request to the terminal device in a subframe n, so as to instruct the terminal device to send the SRS on a second symbol, indicated by the instruction message, in an UpPTS of the first special subframe that meets n+k, where k is an integer greater than or equal to 4.

Optionally, in an implementation of the first aspect, the method is applied to a time division duplex (TDD) system.

According to a second aspect, a method for transmitting a sounding reference signal (SRS) is provided, including:

receiving, by a terminal device, an instruction message sent by a network device, where the instruction message is used to instruct the terminal device to send an SRS on a second symbol in first symbols, the first symbols are symbols in uplink pilot slots (UpPTSs) of two special subframes in a radio frame, and the second symbol is a symbol in an UpPTS of at least one of the two special subframes; and

sending, by the terminal device, the SRS to the network device on the second symbol.

Optionally, in an implementation of the second aspect, the method further includes:

receiving, by the terminal device, at least two SRS configurations sent by the network device, where the at least two SRS configurations include at least two SRS configuration indexes I_{SRS}, and the at least two I_{SRS} are corresponding to the first symbols; and

determining, by the terminal device, the first symbols based on the at least two SRS configurations.

Optionally, in an implementation of the second aspect, the symbols in the UpPTSs include two symbol sets, and there is no intersection between the two symbol sets.

The at least two SRS configurations are used to indicate symbols in at least one of the two symbol sets; and the I_{SRS} is used to indicate an SRS subframe offset and an SRS period, and used to determine the symbols in the symbol set.

Optionally, in an implementation of the second aspect, the at least two SRS configurations include a first SRS configuration, a second SRS configuration, and a third SRS configuration. The first SRS configuration includes a first I_{SRS}, the second SRS configuration includes a second I_{SRS}, and the third SRS configuration includes a third I_{SRS}.

The first I_{SRS} is corresponding to a symbol in a first symbol set of the at least two symbol sets.

The second I_{SRS} and the third I_{SRS} are separately corresponding to symbols in a second symbol set of the at least two symbol sets, where a symbol corresponding to the second I_{SRS} is different from a symbol corresponding to the third I_{SRS}.

Optionally, in an implementation of the second aspect, the at least two SRS configurations include a fourth SRS configuration and a fifth SRS configuration. The fourth SRS configuration includes a fourth I_{SRS}, and the fifth SRS configuration includes a fifth I_{SRS}.

The fourth I_{SRS} is corresponding to a symbol in a first symbol set of the at least two symbol sets.

The fifth I_{SRS} is corresponding to a symbol in a second symbol set of the at least two symbol sets.

Optionally, in an implementation of the second aspect, the fifth I_{SRS} is corresponding to four subframe offsets, and the four subframe offsets are corresponding to four symbols in the second symbol set.

Optionally, in an implementation of the second aspect, an SRS trigger type corresponding to the at least two SRS configurations is a first trigger type or a second trigger type.

When the SRS trigger type corresponding to the at least two SRS configurations is the first trigger type, the at least two SRS configurations and the instruction message are used to instruct to send the SRS to the network device on the second symbol; or

when the SRS type corresponding to the at least two SRS configurations is the second trigger type, the method further includes: receiving, in a subframe n, an SRS request sent by the network device, where the sending the SRS to the network device includes: sending the SRS on a second symbol, indicated by the instruction message, in an UpPTS of the first special subframe that meets n+k, where k is an integer greater than or equal to 4.

Optionally, in an implementation of the second aspect, the method is applied to a time division duplex (TDD) system.

According to a third aspect, a network device is provided, includes a sending unit and a receiving unit, and may perform the method in the first aspect or any one of the optional implementations of the first aspect.

According to a fourth aspect, a terminal device is provided, includes a sending unit and a receiving unit, and may perform the method in the second aspect or any one of the optional implementations of the second aspect.

According to a fifth aspect, a network device is provided, including a memory, a transceiver, and a processor. The memory stores program code that can be used to instruct to perform the first aspect or any one of the optional implementations of the first aspect. When the code is executed, the processor may implement the operations performed by the network device in the method.

According to a sixth aspect, a terminal device is provided, including a memory, a transceiver, and a processor. The memory stores program code that can be used to instruct to perform the second aspect or any one of the optional implementations of the second aspect. When the code is executed, the processor may implement the operations performed by the terminal device in the method.

According to a seventh aspect, a computer readable medium is provided, where the computer readable medium stores program code to be executed by a terminal device, and the program code includes an instruction used to perform the method in the first aspect or in the various implementations of the first aspect.

According to an eighth aspect, a computer readable medium is provided, where the computer readable medium stores program code to be executed by a network device, and the program code includes an instruction used to perform the method in the second aspect or in the various implementations of the second aspect.

### BRIEF DESCRIPTION OF DRAWINGS

FIG. 1 is a schematic diagram of a communications system according to an embodiment of this application;

FIG. 2 is a diagram of a frame structure type in an LTE TDD system for communication between a terminal device and an access network according to an embodiment of this application;

FIG. 3 is a schematic flowchart of a method for transmitting an SRS according to an embodiment of this application;

FIG. 4 is a schematic diagram of carrier switching according to an embodiment of this application;

FIG. 5 is a schematic block diagram of a network device according to an embodiment of this application;

FIG. 6 is a schematic block diagram of a terminal device according to an embodiment of this application; and

FIG. 7 is a schematic block diagram of a communications apparatus according to an embodiment of this application.

### DESCRIPTION OF EMBODIMENTS

The following describes technical solutions in embodiments of the present disclosure with reference to accompanying drawings.

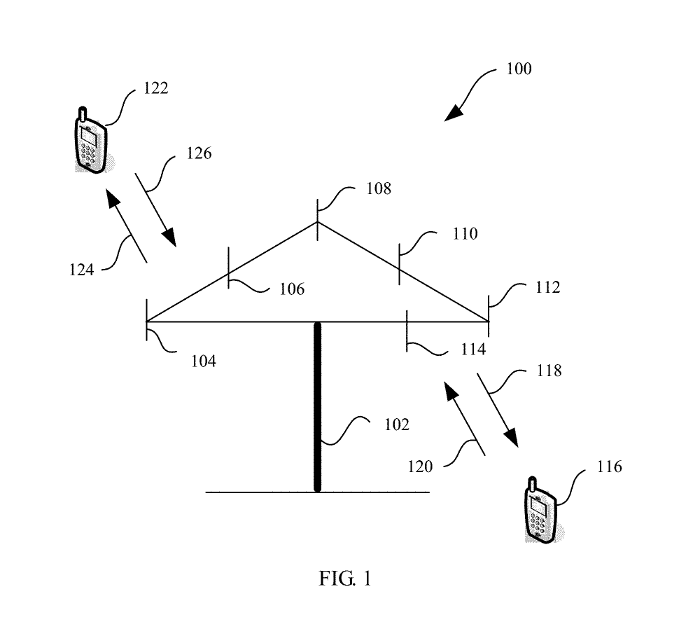

FIG. 1 is a schematic diagram of a communications system for transmitting information according to this application. As shown in FIG. 1, the communications system 100 includes a network device 102, and the network device 102 may include a plurality of antennas, for example, antennas 104, 106, 108, 110, 112, and 114. In addition, the network device 102 may additionally include a transmitter chain and a receiver chain. A person of ordinary skill in the art may understand that the transmitter chain and the receiver chain each may include a plurality of components (for example, a processor, a modulator, a multiplexer, a demodulator, a demultiplexer, or an antenna) related to signal sending and receiving.

The network device 102 may communicate with a plurality of terminal devices (for example, a terminal device 116 and a terminal device 122). However, it may be understood that the network device 102 may communicate with any quantity of terminal devices similar to the terminal device 116 or 122. The terminal devices 116 and 122 may be, for example, cellular phones, smartphones, portable computers, handheld communications devices, handheld computing devices, satellite radio apparatuses, global positioning systems, PDAs, and/or any other appropriate devices configured to perform communication in the wireless communications system 100.

As shown in FIG. 1, the terminal device 116 communicates with the antennas 112 and 114. The antennas 112 and 114 send information to the terminal device 116 over a forward link 118, and receive information from the terminal device 116 over a reverse link 120. In addition, the terminal device 122 communicates with the antennas 104 and 106. The antennas 104 and 106 send information to the terminal device 122 over a forward link 124, and receive information from the terminal device 122 over a reverse link 126.

For example, in a frequency division duplex (FDD) system, the forward link 118 and the reverse link 120 may use different frequency bands, and the forward link 124 and the reverse link 126 may use different frequency bands.

For another example, in a time division duplex (TDD) system and a full duplex system, the forward link 118 and the reverse link 120 may use a same frequency band, and the forward link 124 and the reverse link 126 may use a same frequency band.

Each antenna (or an antenna group that includes a plurality of antennas) and/or area that are/is designed for communication are/is referred to as a sector of the network device 102. For example, the antenna group may be designed to communicate with a terminal device in a sector within a coverage area of the network device 102. In a process in which the network device 102 separately communicates with the terminal devices 116 and 122 over the forward links 118 and 124, a transmit antenna of the network device 102 may improve signal-to-noise ratios of the forward links 118 and 124 through beamforming. In addition, in comparison with a manner in which a network device sends, by using a single antenna, signals to all terminal devices connected to the network device, when the network device 102 sends, through beamforming, signals to the terminal devices 116 and 122 that are randomly scattered in a related coverage area, a mobile device in a neighboring cell is subject to less interference.

At a given time, the network device 102, the terminal device 116, or the terminal device 122 may be a wireless communications sending apparatus and/or a wireless communications receiving apparatus. When sending data, the wireless communications sending apparatus may encode the data for transmission. Specifically, the wireless communications sending apparatus may obtain (for example, generate, receive (from another communications apparatus), or store (in a memory)) a specific quantity of data bits that need to be sent to the wireless communications receiving apparatus through a channel. The data bits may be included in a transport block (or a plurality of transport blocks) of data, and the transport block may be segmented to generate a plurality of code blocks.

In addition, the communications system 100 may be a public land mobile network (PLMN) network, a D2D network, an M2M network, or another network. FIG. 1 is merely a simplified schematic diagram of an example. The network may further include another network device that is not shown in FIG. 1.

This application describes each embodiment in combination with a network device. The network device may be a device that communicates with a terminal device, for example, a base station or a base station controller. Each network device may provide communication coverage for a specific geographic area, and may communicate with a terminal device (for example, a user equipment (UE)) in the coverage area (cell). The network device may be a base transceiver station (BTS) in a GSM system or a CDMA system, or may be a NodeB (NB) in a WCDMA system, or may be an evolved NodeB (eNB or eNodeB) in an LTE system, or a wireless controller in a cloud radio access network (CRAN), or the network device may be a network device in a future 5G network or a network device in a future evolved public land mobile network (PLMN), or the like.

In addition, this application describes each embodiment in combination with a terminal device. The terminal device may be an access terminal, a user equipment (UE), a subscriber unit, a subscriber station, a mobile station, a mobile console, a remote station, a remote terminal, a mobile terminal, a user terminal, a terminal, a wireless communications device, a user agent, or a user apparatus. The access terminal may be a cellular phone, a cordless phone, a Session Initiation Protocol (SIP) phone, a wireless local loop (WLL) station, a personal digital assistant (PDA), a handheld device having a wireless communication function, a computing device, another processing device connected to a wireless modem, an in-vehicle device, a wearable device, a terminal device in the Internet of Things, a virtual reality device, a terminal device in a future 5G network, a terminal device in a future evolved public land mobile network (PLMN), or the like.

A method and an apparatus for transmitting a sounding reference signal provided in the embodiments of this application may be applied to the terminal device or the network device. The terminal device or the network device includes a hardware layer, an operating system layer running at the hardware layer, and an application layer running at the operating system layer. The hardware layer includes hardware such as a central processing unit (CPU), a memory management unit (MMU), and a memory (also referred to as a main memory). The operating system may be any one or more computer operating systems that implement service processing by using a process, for example, a Linux operating system, a Unix operating system, an Android operating system, an iOS operating system, or a Windows operating system. The application layer includes applications such as a browser, an address book, word processing software, and instant messaging software. In addition, in the embodiments of this application, a specific structure of an entity for performing the method for transmitting a sounding reference signal is not specially limited in this application, provided that a program recording code of the method for transmitting a signal in the embodiments of this application can be run to perform communication according to the method for transmitting a signal in the embodiments of this application. For example, the entity for performing the method for transmitting feedback information in the embodiments of this application may be the terminal device or the network device, or a functional module that is in the terminal device or the network device and that can invoke a program and execute the program.

In addition, aspects or features of this application may be implemented as a method, an apparatus, or a product that uses standard programming and/or engineering technologies. The term “product” used in this application covers a computer program that can be accessed from any computer readable device, carrier, or medium. For example, the computer readable medium may include but is not limited to: a magnetic storage device (for example, a hard disk, a floppy disk, or a magnetic tape), an optical disc (for example, a compact disc (CD), or a digital versatile disc (DVD)), a smart card, and a flash memory device (for example, an erasable programmable read-only memory (EPROM), a card, a stick, or a key drive). In addition, various storage media described in this specification may indicate one or more devices and/or other machine readable media that are configured to store information. The term “machine readable medium” may include but is not limited to a radio channel, and various other media that can store, include, and/or carry an instruction and/or data.

It should be understood that the technical solutions in the embodiments of this application may be applied to an LTE TDD system. As an example instead of a limitation, any wireless communications system that transmits data through scheduling is applicable to the embodiments of this application. To better understand this application, the LTE TDD system is used as an example to describe the embodiments of this application.

It should be understood that an uplink symbol is referred to as a single carrier frequency division multiple access (SC-FDMA) symbol, and a downlink symbol is referred to as an orthogonal frequency division multiple access (OFDMA) symbol. It should be noted that if an uplink multiple access mode of OFDMA is introduced in a subsequent technology, the uplink symbol may also be referred to as an OFDMA symbol. In the embodiments of this application, both the uplink symbol and the downlink symbol are collectively referred to as symbols, or may be symbols of communication of another type. This is not limited in the embodiments of this application.

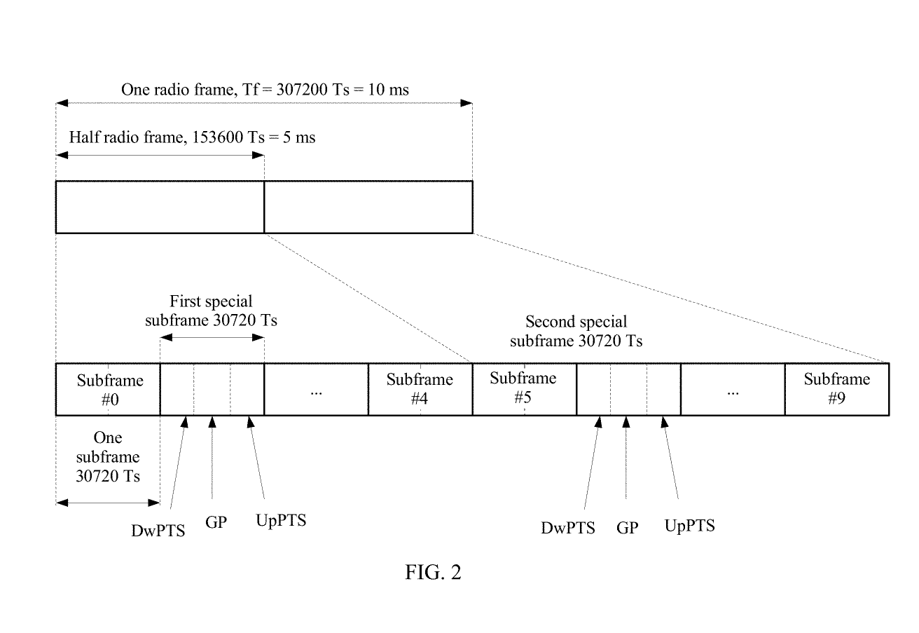

FIG. 2 shows a frame structure type in an LTE TDD system for communication between a terminal device and an access network according to an embodiment of this application. As shown in FIG. 2, in a frame structure of the LTE TDD system, one radio frame with a period of 10 ms includes two special subframes. Each of the two special subframes includes three parts: a downlink pilot slot DwPTS, a guard period GP, and an uplink pilot slot UpPTS. A symbol in the DwPTS part is used for downlink transmission, a symbol in the UpPTS is used for uplink transmission, and the GP is a guard period used for handover from downlink to uplink.

It should be understood that an SRS in this embodiment of this application may be transmitted on a symbol in an UpPTS in one special subframe.

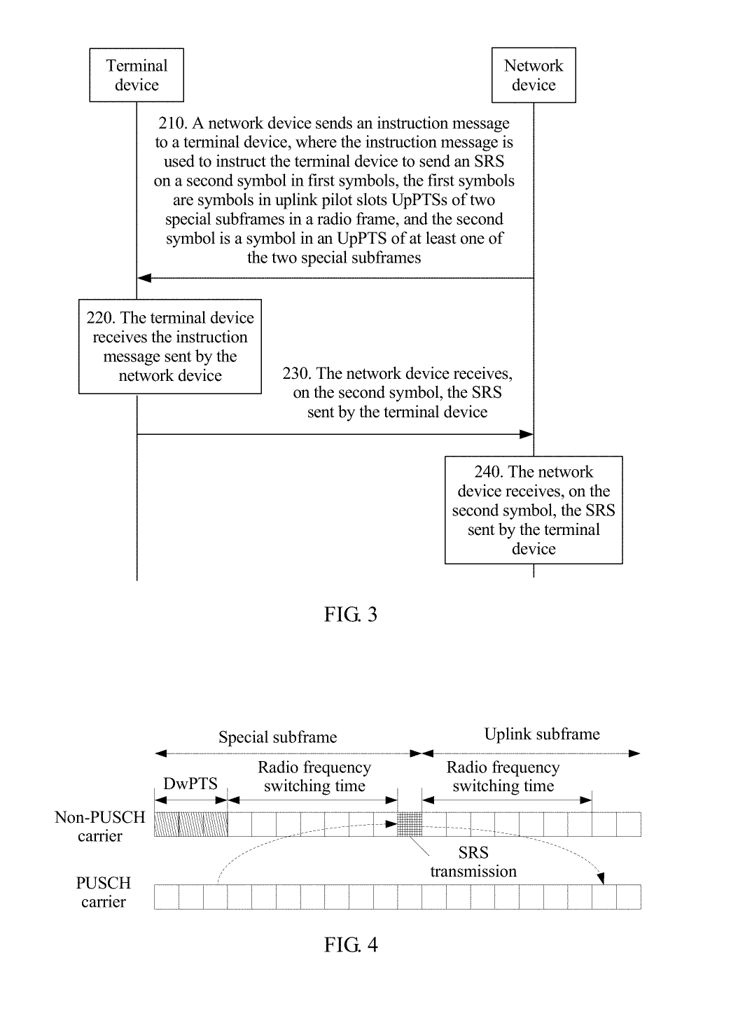

FIG. 3 is a schematic flowchart of a method 200 for transmitting a sounding reference signal (SRS) according to an embodiment of this application. As shown in FIG. 3, the method 200 includes the following content.

In 210, a network device sends an instruction message to a terminal device, where the instruction message is used to instruct the terminal device to send an SRS on a second symbol in first symbols, the first symbols are symbols in UpPTSs of two special subframes in a radio frame, and the second symbol is a symbol in an UpPTS of at least one of the two special subframes.

It should be understood that a first special subframe and a second special subframe exist in the radio frame, and the first symbols are symbols in both an uplink pilot slot UpPTS of the first special subframe and an uplink pilot slot UpPTS of the second special subframe.

It should be understood that the first special subframe and the second special subframe exist in the radio frame, and the second symbol has three cases:

Case 1: The second symbol is a symbol that belongs to the UpPTS of the first special subframe.

Case 2: The second symbol is a symbol that belongs to the UpPTS of the second special subframe.

Case 3: The second symbol is both a symbol in the UpPTS of the first special subframe and a symbol in the UpPTS of the second special subframe.

It should be understood that the second symbol is a part or all of the first symbols.

Optionally, the instruction message is used to instruct the terminal device to send the SRS on the second symbol.

Specifically, the instruction message is used to instruct the terminal device to send the SRS on a symbol in the UpPTS of the first special subframe; or

the instruction message is used to instruct the terminal device to send the SRS on a symbol in the UpPTS of the second special subframe; or

the instruction message is used to instruct the terminal device to send the SRS on both symbols in the UpPTSs of the first special subframe and the second special subframe.

Optionally, in this embodiment of this application, the network device may send the instruction message over a first carrier, where the first carrier may be further used by the terminal device to send uplink data to the network device.

Specifically, in a communications system, a carrier aggregation (CA) technology is supported, that is, a plurality of carriers are used to serve a user at the same time, to increase a system throughput and a user throughput. Load of a downlink service is usually heavier than that of an uplink service. Therefore, a quantity of component carriers (CC) of downlink carrier aggregation is usually greater than a quantity of CCs of uplink carrier aggregation. For UE with a CA capability, a quantity of downlink aggregation carriers supported by the UE is usually greater than a quantity of uplink aggregation carriers. Therefore, there is no uplink transmission, including an SRS, on some carriers that support downlink transmission, and these carriers become non-physical downlink shared channel (non-PUSCH) transmission carriers. On these carriers, the network device cannot obtain downlink channel information by using an SRS and channel reciprocity. Therefore, an uplink carrier may be quickly switched to allow the UE to send the SRS in uplink on a non-PUSCH transmission carrier, so as to obtain downlink channel information of a corresponding carrier.

In 220, the terminal device receives the instruction message sent by the network device.

In 230, the terminal device sends the SRS to the network device on the second symbol according to the instruction message.

In 240, the network device receives, on the second symbol, the SRS sent by the terminal device.

It should be understood that a quantity of second symbols for sending the SRS may be determined depending on an implementation situation, and is not specifically limited in this embodiment of this application. For example, there may be one second symbol, or there may be two, three, or more second symbols.

Therefore, in this embodiment of this application, the network device sends the instruction message to the terminal device, to instruct the terminal device to send the SRS on a symbol in an UpPTS of at least one of the two special subframes in the radio frame, so that symbol overheads during SRS transmission can be significantly reduced.

In addition, the terminal device is further instructed to send the SRS on the symbol in the UpPTS of the at least one of the two special subframes in the radio frame, so as to avoid frequent carrier switching, and reduce carrier switching overheads.

Specifically, based on the foregoing descriptions, an uplink carrier is quickly switched to allow the UE to send the SRS in uplink on a non-PUSCH transmission carrier, so as to obtain downlink channel information of a corresponding carrier. Because the UE needs to switch a radio frequency to another carrier, a specific switching time is required. A maximum switching time that is currently defined is 500 μs; in other words, approximately seven symbols are required. FIG. 4 is used as an example. If it is necessary to switch to a non-physical downlink shared channel (non-PUSCH) transmission carrier and send the SRS on a last symbol in a special subframe of the carrier, seven symbols preceding the symbol for sending the SRS need to be used as a radio frequency switching time. After the SRS is sent, a radio frequency switching time of seven symbols is further required for switching back to a PUSCH transmission carrier. If the SRS needs to be sent for a plurality of times, and only one symbol is sent at a time, total carrier switching overheads are very large. It can be learned that when carrier switching is performed to send the SRS, overheads of a required radio frequency switching time are quite large, because within the radio frequency switching time, the UE cannot perform sending or receiving, and uplink transmission and downlink transmission of these symbols are affected.

Therefore, in this embodiment of this application, the terminal device is instructed to send the SRS on the symbol in the UpPTS of the at least one of the two special subframes in the radio frame, so as to avoid frequent carrier switching for SRS transmission, and reduce carrier switching overheads.

Optionally, in this embodiment of this application, the network device sends at least two SRS configurations to the terminal device, the at least two SRS configurations include at least two SRS configuration indexes I_{SRS}, and the at least two I_{SRS} are corresponding to the first symbols.

Optionally, the terminal device may complete the at least two SRS configurations in advance as required.

Optionally, the at least two SRS configurations may be implemented according to a same configuration policy, or may be implemented according to different configuration policies. In addition, the configuration policy may be based on a release earlier than the LTE Release 13, that is, one or two symbols in an UpPTS are configured for UE to send an SRS; or may be based on the LTE Release 13, that is, one or two symbols in two or four symbols in an UpPTS are configured for UE to send an SRS. Alternatively, a new configuration policy may be defined: Four symbols in an UpPTS are configured for UE to send an SRS.

Optionally, the at least two SRS configurations are sent by the network device to the terminal device. The network device may send the at least two SRS configurations to the terminal device in advance as required, or may send the at least two SRS configurations together with the instruction message to the terminal device; or the at least two SRS configurations may be loaded into the instruction message and sent to the terminal device together with the instruction message.

Optionally, the at least two SRS configurations may be two SRS configurations, or may be three SRS configurations, four SRS configurations, five SRS configurations, or even more SRS configurations. This is not specifically limited in this embodiment of this application.

Optionally, the at least two SRS configurations include at least two SRS configuration indexes I_{SRS}, and one SRS configuration includes one SRS configuration index I_{SRS}.

Optionally, the at least two I_{SRS} are corresponding to the first symbols, and there is a correspondence between the I_{SRS} and the first symbols.

Optionally, in this embodiment of this application, the symbols in the UpPTSs include two symbol sets, and there is no intersection between the two symbol sets.

The at least two SRS configurations are used to indicate symbols in at least one of the two symbol sets; and the I_{SRS} is used to indicate an SRS subframe offset and an SRS period, and used to determine the symbols in the symbol set.

Optionally, there are two symbol sets in symbols in an UpPTS of each of the two special subframes, the two symbol sets have no intersection, and symbols in the two symbol sets are separately corresponding to different SRS configurations.

It should be understood that the two symbol sets are used to better present that the symbols in the two symbol sets are separately corresponding to different SRS configurations, and there is no necessary subordination relationship between a symbol and a symbol set.

Optionally, the at least two SRS configurations are used to indicate symbols in at least one of the two symbol sets.

For example, a first SRS configuration may be used to indicate a symbol in a first symbol set, a second SRS configuration may be used to indicate a symbol in a second symbol set, and another SRS configuration may also be used to indicate a symbol in the second symbol set.

Alternatively, a first SRS configuration may be used to indicate a symbol in a first symbol set, a second SRS configuration may be used to indicate a symbol in a second symbol set, and another SRS configuration may also be used to indicate a symbol in the first symbol set.

Alternatively, all SRS configurations are used to indicate symbols in a first symbol set.

Alternatively, all SRS configurations are used to indicate symbols in a second symbol set.

Optionally, the I_{SRS} is used to indicate the SRS subframe offset and the SRS period.

Optionally, the SRS period may be a period of a special subframe.

Optionally, according to the following Table 1 to Table 5, the SRS subframe offset and the SRS period may be queried based on the I_{SRS}.

TABLE 1

| SRS configuration | SRS period | SRS subframe |
|---|---|---|
| index I_{SRS} | T_{SRS} (ms) | offset T_{offset} |
| 0 | 2 | 0, 1 |
| 1 | 2 | 0, 2 |
| 2 | 2 | 1, 2 |
| 3 | 2 | 0, 3 |
| 4 | 2 | 1, 3 |
| 5 | 2 | 0, 4 |
| 6 | 2 | 1, 4 |
| 7 | 2 | 2, 3 |
| 8 | 2 | 2, 4 |
| 9 | 2 | 3, 4 |
| 10-14 | 5 | I_{SRS} − 10 |
| 15-24 | 10 | I_{SRS} − 15 |
| 25-44 | 20 | I_{SRS} − 25 |
| 45-84 | 40 | I_{SRS} − 45 |
| 85-164 | 80 | I_{SRS} − 85 |
| 165-324 | 160 | I_{SRS} − 165 |
| 325-644 | 320 | I_{SRS} − 325 |
| 645-1023 | Reserved | Reserved |

TABLE 2

| SRS configuration | SRS period | SRS subframe |
|---|---|---|
| index I_{SRS} | T_{SRS, 1} (ms) | offset T_{offset, 1} |
| 0 | Reserved | Reserved |
| 1 | 2 | 0, 2 |
| 2 | 2 | 1, 2 |
| 3 | 2 | 0, 3 |
| 4 | 2 | 1, 3 |
| 5 | 2 | 0, 4 |
| 6 | 2 | 1, 4 |
| 7 | 2 | 2, 3 |
| 8 | 2 | 2, 4 |
| 9 | 2 | 3, 4 |
| 10-14 | 5 | I_{SRS} − 10 |
| 15-24 | 10 | I_{SRS} − 15 |
| 25-31 | Reserved | Reserved |

TABLE 3

| SRS configuration | SRS period | SRS subframe |
|---|---|---|
| index I_{SRS} | T_{SRS, 1} (ms) | offset T_{offset, 1} |
| 0 | 2 | 0, 1 |
| 1 | 2 | 0, 2 |
| 2 | 2 | 1, 2 |
| 3 | 2 | 0, 3 |
| 4 | 2 | 1, 3 |
| 5 | 2 | 0, 4 |
| 6 | 2 | 1, 4 |
| 7 | 2 | 2, 3 |
| 8 | 2 | 2, 4 |
| 9 | 2 | 3, 4 |
| 10-14 | 5 | I_{SRS} − 10 |
| 15-24 | 10 | I_{SRS} − 15 |
| 25-31 | Reserved | Reserved |

TABLE 4

| SRS configuration | SRS period | SRS subframe |
|---|---|---|
| index I_{SRS} | T_{SRS} (ms) | offset T_{offset} |
| 0 | 2 | 0, 1 |
| 1 | 2 | 0, 2 |
| 2 | 2 | 1, 2 |
| 3 | 2 | 0, 3 |
| 4 | 2 | 1, 3 |
| 5 | 2 | 0, 4 |
| 6 | 2 | 1, 4 |
| 7 | 2 | 2, 3 |
| 8 | 2 | 2, 4 |
| 9 | 2 | 3, 4 |
| 10-14 | 5 | I_{SRS} − 10 |
| 15-24 | 10 | I_{SRS} − 15 |
| 25-44 | 20 | I_{SRS} − 25 |
| 45-84 | 40 | I_{SRS} − 45 |
| 85-164 | 80 | I_{SRS} − 85 |
| 165-324 | 160 | I_{SRS} − 165 |
| 325-644 | 320 | I_{SRS} − 325 |
| 645 | 2 | 0, 1, 2, 3 |
| 646 | 2 | 5, 6, 7, 8 |
| 647-1023 | Reserved | Reserved |

TABLE 5

| SRS configuration | SRS period | SRS subframe |
|---|---|---|
| index I_{SRS} | T_{SRS, 1} (ms) | offset T_{offset, 1} |
| 0 | Reserved | Reserved |
| 1 | 2 | 0, 2 |
| 2 | 2 | 1, 2 |
| 3 | 2 | 0, 3 |
| 4 | 2 | 1, 3 |
| 5 | 2 | 0, 4 |
| 6 | 2 | 1, 4 |
| 7 | 2 | 2, 3 |
| 8 | 2 | 2, 4 |
| 9 | 2 | 3, 4 |
| 10-14 | 5 | I_{SRS} − 10 |
| 15-24 | 10 | I_{SRS} − 15 |
| 25 | 2 | 0, 1, 2, 3 |
| 26 | 2 | 5, 6, 7, 8 |
| 27-31 | Reserved | Reserved |

Table 1 shows a correspondence among an I_{SRS}, an SRS subframe offset, and an SRS period in a case of a trigger type 0. Table 2 shows a correspondence among an I_{SRS}, an SRS subframe offset, and an SRS period in a case of a trigger type 1.

Optionally, as shown in Table 3, in the case of the trigger type 1, (0, 1) is assigned to an SRS subframe offset T_{offset} corresponding to I_{SRS}=0, and T_{SRS}=2 ms is assigned to an SRS period.

Optionally, as shown in Table 4, a new configuration policy is used. In the case of the trigger type 0, (0, 1, 2, 3) is assigned to an SRS subframe offset T_{offset} corresponding to I_{SRS}=645, and T_{SRS}=2 ms is assigned to an SRS period; or (5, 6, 7, 8) is assigned to an SRS subframe offset T_{offset} corresponding to I_{SRS}=646, and T_{SRS}=2 ms is assigned to an SRS period.

Optionally, as shown in Table 5, a new configuration policy is used. In the case of the trigger type 1, (0, 1, 2, 3) is assigned to an SRS subframe offset T_{offset} corresponding to I_{SRS}=25, and T_{SRS}=2 ms is assigned to an SRS period; or (5, 6, 7, 8) is assigned to an SRS subframe offset T_{offset} corresponding to I_{SRS}=26, and T_{SRS}=2 ms is assigned to an SRS period.

Optionally, a symbol in the symbol set is determined based on an SRS subframe offset and an SRS period that are indicated by the I_{SRS}, a symbol location in the symbol set may be determined based on the SRS subframe offset, and a symbol for sending the SRS is determined based on the symbol location.

The symbol location in the symbol set may be determined based on the following formula 1:

T_{SRS}=2 ms and (K_{SRS}−T_{offset})mod 5=0 Formula 1

T_{SRS} indicates an SRS period, T_{offset} indicates an SRS subframe offset, and K_{SRS} indicates an SRS symbol location to which T_{offset} is mapped.

The symbol location in the symbol set may be alternatively determined based on the following formula 2:

T_{SRS}=2 ms and (K_{SRS}−T_{offset}) mod 10=0 Formula 2

T_{SRS} indicates an SRS period, T_{offset} indicates an SRS subframe offset, and K_{SRS} indicates an SRS symbol location to which T_{offset} is mapped.

Optionally, K_{SRS} may be selected from the following Table 6 and Table 7:

TABLE 6

| | Subframe index n | | | | | | | | | | | |
|---|---|---|---|---|---|---|---|---|---|---|---|---|
| | | 1 | | | | | | 6 | | | | |
| | | First | Second | | | | | First | Second | | | |
| | 0 | symbol | symbol | 2 | 3 | 4 | 5 | symbol | symbol | 7 | 8 | 9 |
| k_{SRS} when | | 0 | 1 | 2 | 3 | 4 | | 5 | 6 | 7 | 8 | 9 |
| there are | | | | | | | | | | | | |
| two | | | | | | | | | | | | |
| consecutive | | | | | | | | | | | | |
| symbols in | | | | | | | | | | | | |
| an UpPTS | | | | | | | | | | | | |
| k_{SRS} when | | 1 | | 2 | 3 | 4 | | 6 | | 7 | 8 | 9 |
| there is one | | | | | | | | | | | | |
| symbol in | | | | | | | | | | | | |
| an UpPTS | | | | | | | | | | | | |

TABLE 7

| | Subframe index n | | | | | | | | | | | | | | | |
|---|---|---|---|---|---|---|---|---|---|---|---|---|---|---|---|---|
| | | 1 | | | | | | | | 6 | | | | | | |
| | | First | Second | Third | Fourth | | | | | First | Second | Third | Fourth | | | |
| | 0 | symbol | symbol | symbol | symbol | 2 | 3 | 4 | 5 | symbol | symbol | symbol | symbol | 7 | 8 | 9 |
| k_{SRS} | | 0 | 1 | 2 | 3 | | | | | 5 | 6 | 7 | 8 | | | |
| when | | | | | | | | | | | | | | | | |
| there | | | | | | | | | | | | | | | | |
| are | | | | | | | | | | | | | | | | |
| four | | | | | | | | | | | | | | | | |
| consecutive | | | | | | | | | | | | | | | | |
| symbols | | | | | | | | | | | | | | | | |
| in an | | | | | | | | | | | | | | | | |
| UpPTS | | | | | | | | | | | | | | | | |
| k_{SRS} | | 2 | 3 | | | | | | | 7 | 8 | | | | | |
| when | | | | | | | | | | | | | | | | |
| there | | | | | | | | | | | | | | | | |
| are two | | | | | | | | | | | | | | | | |
| consecutive | | | | | | | | | | | | | | | | |
| symbols | | | | | | | | | | | | | | | | |
| in an | | | | | | | | | | | | | | | | |
| UpPTS | | | | | | | | | | | | | | | | |

In Table 6, the subframe index 1 is corresponding to K_{SRS}=(0, 1) when there are two consecutive symbols in the UpPTS, and is corresponding to K_{SRS}=1 when there is one symbol in the UpPTS. The subframe index 6 is corresponding to K_{SRS}=(5, 6) when there are two consecutive symbols in the UpPTS, and is corresponding to K_{SRS}=6 when there is one symbol in the UpPTS.

In Table 7, the subframe index 1 is corresponding to K_{SRS}=(0, 1, 2, 3) when there are four consecutive symbols in the UpPTS, and is corresponding to K_{SRS}=(2, 3) when there are two consecutive symbols in the UpPTS. The subframe index 6 is corresponding to K_{SRS}=(5, 6, 7, 8) when there are two consecutive symbols in the UpPTS, and is corresponding to K_{SRS}=(7, 8) when there is one symbol in the UpPTS.

Optionally, in this embodiment of this application, the at least two SRS configurations include a first SRS configuration, a second SRS configuration, and a third SRS configuration. The first SRS configuration includes a first I_{SRS}, the second SRS configuration includes a second I_{SRS}, and the third SRS configuration includes a third I_{SRS}.

The first I_{SRS} is corresponding to a symbol in a first symbol set of the at least two symbol sets.

The second I_{SRS} and the third I_{SRS} are separately corresponding to symbols in a second symbol set of the at least two symbol sets, where a symbol corresponding to the second I_{SRS} is different from a symbol corresponding to the third I_{SRS}.

Optionally, in an implementation of the first aspect, there is a symbol spacing between any two symbol sets in the at least two symbol sets.

Optionally, when SRS trigger types are different, the first I_{SRS}, the second I_{SRS}, and the third I_{SRS} are queried in different tables, and values corresponding to the first I_{SRS}, the second I_{SRS}, and the third I_{SRS} are different.

When an SRS trigger type is 0, the first I_{SRS}, the second I_{SRS}, and the third I_{SRS} are queried in Table 1.

When an SRS trigger type is 1, the first I_{SRS} is queried in Table 3, and the second I_{SRS} and the third I_{SRS} are queried in Table 2.

Optionally, when the SRS trigger type is 0, the first SRS configuration includes the first I_{SRS}. The first SRS configuration may be implemented according to a configuration policy in a release earlier than the LTE Release 13, that is, one or two symbols in an UpPTS are configured for UE. The first I_{SRS} may be selected from Table 1. The K_{SRS} may be selected from Table 6. The first I_{SRS} is 0, a subframe offset T_{offset} corresponding to the first I_{SRS}=0 is (0, 1), and a symbol location K_{SRS} to which the subframe offset T_{offset} (0, 1) is mapped is (0, 1).

When the SRS trigger type is 0, the second SRS configuration includes the second I_{SRS}. The second SRS configuration may be implemented according to a configuration policy in the LTE Release 13, that is, one or two symbols in two or four symbols in an UpPTS are configured for UE. The second I_{SRS} may be selected from Table 1, and the K_{SRS} may be selected from Table 7.

When the SRS trigger type is 0, the third SRS configuration includes the third I_{SRS}. The third SRS configuration may be implemented according to a configuration policy in the LTE Release 13, that is, one or two symbols in two or four symbols in an UpPTS are configured for UE. The third I_{SRS} may be selected from Table 1, and the K_{SRS} may be selected from Table 7.

Specifically, when the second I_{SRS} is 0, a subframe offset T_{offset} corresponding to the second I_{SRS}=0 is (0, 1), and a symbol location K_{SRS} to which the subframe offset T_{offset} (0, 1) is mapped is (0, 1); and when the third I_{SRS} is 7, a subframe offset T_{offset} corresponding to the third I_{SRS}=7 is (2, 3), and a symbol location K_{SRS} to which the subframe offset T_{offset} (2, 3) is mapped is (2, 3); or

when the second I_{SRS} is 1, a subframe offset T_{offset} corresponding to the second I_{SRS}=1 is (0, 2), and a symbol location K_{SRS} to which the subframe offset T_{offset} (0, 2) is mapped is (0, 2); and when the third I_{SRS} is 4, a subframe offset T_{offset} corresponding to the third I_{SRS}=4 is (1, 3), and a symbol location K_{SRS} to which the subframe offset T_{offset} (1, 3) is mapped is (1, 3); or

when the second I_{SRS} is 2, a subframe offset T_{offset} corresponding to the second I_{SRS}=2 is (1, 2), and a symbol location K_{SRS} to which the subframe offset T_{offset} (1, 2) is mapped is (1, 2); and when the third I_{SRS} is 3, a subframe offset T_{offset} corresponding to the third I_{SRS}=3 is (0, 3), and a symbol location K_{SRS} to which the subframe offset T_{offset} (0, 3) is mapped is (0, 3).

It should be understood that the subframe offset T_{offset} corresponding to the first I_{SRS} may be mapped to two symbol locations in the first symbol set, the subframe offset T_{offset} corresponding to the second I_{SRS} may be mapped to two symbol locations in the second symbol set, and the subframe offset T_{offset} corresponding to the third I_{SRS} may be mapped to two symbol locations in the second symbol set. The two symbol locations in the second symbol set and to which the subframe offset T_{offset} corresponding to the second I_{SRS} is mapped are different from the two symbol locations in the second symbol set and to which the subframe offset T_{offset} corresponding to the third I_{SRS} is mapped.

It should be understood that the terminal device may determine, based on the symbol location K_{SRS}, a specific symbol for sending the SRS.

Optionally, when the SRS trigger type is 1, the first SRS configuration includes the first I_{SRS}. The first SRS configuration may be implemented according to a configuration policy in a release earlier than the LTE Release 13, that is, one or two symbols in an UpPTS are configured for UE. The first I_{SRS} may be selected from Table 3. The K_{SRS} may be selected from Table 6. The first I_{SRS} is 0, a subframe offset T_{offset} corresponding to the first I_{SRS}=0 is (0, 1), and a symbol location K_{SRS} to which the subframe offset T_{offset} (0, 1) is mapped is (0, 1).

When the SRS trigger type is 1, the second SRS configuration includes the second I_{SRS}. The second SRS configuration may be implemented according to a configuration policy in the LTE Release 13, that is, one or two symbols in two or four symbols in an UpPTS are configured for UE. The second I_{SRS} may be selected from Table 2, and the K_{SRS} may be selected from Table 7.

When the SRS trigger type is 1, the third SRS configuration includes the third I_{SRS}. The third SRS configuration may be implemented according to a configuration policy in the LTE Release 13, that is, one or two symbols in two or four symbols in an UpPTS are configured for UE. The third I_{SRS} may be selected from Table 2, and the K_{SRS} may be selected from Table 7.

Specifically, when the second I_{SRS} is 1, a subframe offset T_{offset} corresponding to the second I_{SRS}=1 is (0, 2), and a symbol location K_{SRS} to which the subframe offset T_{offset} (0, 2) is mapped is (0, 2); and when the third I_{SRS} is 4, a subframe offset T_{offset} corresponding to the third I_{SRS}=4 is (1, 3), and a symbol location K_{SRS} to which the subframe offset T_{offset} (1, 3) is mapped is (1, 3); or

when the second I_{SRS} is 2, a subframe offset T_{offset} corresponding to the second I_{SRS}=2 is (1, 2), and a symbol location K_{SRS} to which the subframe offset T_{offset} (1, 2) is mapped is (1, 2); and when the third I_{SRS} is 3, a subframe offset T_{offset} corresponding to the third I_{SRS}=3 is (0, 3), and a symbol location K_{SRS} to which the subframe offset T_{offset} (0, 3) is mapped is (0, 3).

It should be understood that the subframe offset T_{offset} corresponding to the first I_{SRS} may be mapped to two symbol locations in the first symbol set, the subframe offset T_{offset} corresponding to the second I_{SRS} may be mapped to two symbol locations in the second symbol set, and the subframe offset T_{offset} corresponding to the third I_{SRS} may be mapped to two symbol locations in the second symbol set. The two symbol locations in the second symbol set and to which the subframe offset T_{offset} corresponding to the second I_{SRS} is mapped are different from the two symbol locations in the second symbol set and to which the subframe offset T_{offset} corresponding to the third I_{SRS} is mapped.

It should be understood that the terminal device may determine, based on the symbol location K_{SRS}, a specific symbol for sending the SRS.

Optionally, in this embodiment of this application, the at least two SRS configurations include a fourth SRS configuration and a fifth SRS configuration. The fourth SRS configuration includes a fourth I_{SRS}, and the fifth SRS configuration includes a fifth I_{SRS}.

The fourth I_{SRS} is corresponding to a symbol in a first symbol set of the at least two symbol sets.

The fifth I_{SRS} is corresponding to a symbol in a second symbol set of the at least two symbol sets.

Optionally, when SRS trigger types are different, the fourth I_{SRS} and the fifth I_{SRS} are queried in different tables, and values corresponding to the fourth I_{SRS} and the fifth I_{SRS} are different.

When the SRS trigger type is 0, the fourth I_{SRS} is queried in Table 1, and the fifth I_{SRS} is queried in Table 4.

When the SRS trigger type is 1, the fourth I_{SRS} is queried in Table 3, and the fifth I_{SRS} is queried in Table 5.

Optionally, when the SRS trigger type is 0, the fourth SRS configuration includes the fourth I_{SRS}. The fourth SRS configuration may be implemented according to a configuration policy in a release earlier than the LTE Release 13, that is, one or two symbols in an UpPTS are configured for UE. The fourth I_{SRS} may be selected from Table 1. The K_{SRS} may be selected from Table 6. The fourth I_{SRS} is 0, a subframe offset T_{offset} corresponding to the fourth I_{SRS}=0 is (0, 1), and a symbol location K_{SRS} to which the subframe offset T_{offset} (0, 1) is mapped is (0, 1).

When the SRS trigger type is 0, the fifth SRS configuration includes the fifth I_{SRS}. The fifth SRS configuration may be implemented according to a new configuration policy, that is, four symbols in an UpPTS are configured for UE. The fifth I_{SRS} may be selected from Table 4, and the K_{SRS} may be selected from Table 7.

Specifically, the fifth I_{SRS} is 645, a subframe offset T_{offset} corresponding to the second I_{SRS}=645 is (0, 1, 2, 3), and a symbol location K_{SRS} to which the subframe offset T_{offset} (0, 1, 2, 3) is mapped is (0, 1, 2, 3); or

the fifth I_{SRS} is 646, a subframe offset T_{offset} corresponding to the second I_{SRS}=646 is (5, 6, 7, 8), and a symbol location K_{SRS} to which the subframe offset T_{offset} (5, 6, 7, 8) is mapped is (5, 6, 7, 8).

Optionally, the subframe offset T_{offset} corresponding to the first I_{SRS} may be mapped to two symbol locations in the first symbol set, and the subframe offset T_{offset} corresponding to the fifth I_{SRS} may be mapped to four symbol locations in the second symbol set.

It should be understood that the terminal device may determine, based on the symbol location K_{SRS}, a specific symbol for sending the SRS.

Optionally, when the SRS trigger type is 1, the fourth SRS configuration includes the fourth I_{SRS}. The fourth SRS configuration may be implemented according to a configuration policy in a release earlier than the LTE Release 13, that is, one or two symbols in an UpPTS are configured for UE. The fourth I_{SRS} may be selected from Table 3. The K_{SRS} may be selected from Table 6. The fourth I_{SRS} is 0, a subframe offset T_{offset} corresponding to the fourth I_{SRS}=0 is (0, 1), and a symbol location K_{SRS} to which the subframe offset T_{offset} (0, 1) is mapped is (0, 1).

When the SRS trigger type is 1, the fifth SRS configuration includes the fifth I_{SRS}. The fifth SRS configuration may be implemented according to a new configuration policy, that is, four symbols in an UpPTS are configured for UE. The fifth I_{SRS} may be selected from Table 5, and the K_{SRS} may be selected from Table 7.

Specifically, the fifth I_{SRS} is 25, a subframe offset T_{offset} corresponding to the second I_{SRS}=25 is (0, 1, 2, 3), and a symbol location K_{SRS} to which the subframe offset T_{offset} (0, 1, 2, 3) is mapped is (0, 1, 2, 3); or

the fifth I_{SRS} is 26, a subframe offset T_{offset} corresponding to the second I_{SRS}=26 is (5, 6, 7, 8), and a symbol location K_{SRS} to which the subframe offset T_{offset} (5, 6, 7, 8) is mapped is (5, 6, 7, 8).

Optionally, the subframe offset T_{offset} corresponding to the first I_{SRS} may be mapped to two symbol locations in the first symbol set, and the subframe offset T_{offset} corresponding to the fifth I_{SRS} may be mapped to four symbol locations in the second symbol set.

Optionally, the terminal device may determine, based on the symbol location K_{SRS}, a specific symbol for sending the SRS.

Optionally, in this embodiment of this application, an SRS trigger type corresponding to the at least two SRS configurations is a first trigger type or a second trigger type.

When the SRS trigger type corresponding to the at least two SRS configurations is the first trigger type, the at least two SRS configurations and the instruction message are used to instruct the terminal device to send the SRS on the second symbol; or

when the SRS type corresponding to the at least two SRS configurations is the second trigger type, the method further includes: sending an SRS request to the terminal device in a subframe n, so as to instruct the terminal device to send the SRS on a second symbol, indicated by the instruction message, in an UpPTS of the first special subframe that meets n+k, where k is an integer greater than or equal to 4.

Optionally, an SRS trigger type corresponding to the at least two SRS configurations is a first trigger type or a second trigger type, the first trigger type may be a trigger type 0, and the second trigger type may be a trigger type 1.

Optionally, when the SRS trigger type corresponding to the at least two SRS configurations is the first trigger type, the at least two SRS configurations and the instruction message are used together to instruct the terminal device to send the SRS on the second symbol.

Optionally, when the SRS trigger type is the first trigger type, the instruction message instructs the terminal device that needs to send the SRS to send the SRS in an UpPTS of a special subframe that periodically occurs.

Optionally, when the SRS type corresponding to the at least two SRS configurations is the second trigger type, the network device sends an SRS request to the terminal device in a subframe n. The request is used to instruct the terminal device to send the SRS on a second symbol, indicated by the instruction message, in an UpPTS of the first special subframe that meets n+k, where k is an integer greater than or equal to 4.

Optionally, the SRS request is sent to the terminal device in the subframe n, and there may be a plurality of special subframes indicated by the instruction message sent by the network device. However, the SRS is sent only on the second symbol in the UpPTS of the first special subframe that meets n+k, where k is an integer greater than or equal to 4.

In this case, symbols for sending the SRS may be some symbols in second symbols in the UpPTS of the first special subframe that meets n+k, or may be all symbols in second symbols in the UpPTS of the first special subframe that meets n+k.

Optionally, in this embodiment of this application, the method is applied to a time division duplex (TDD) system.

Therefore, in this embodiment of this application, the network device sends the instruction message to the terminal device, to instruct the terminal device to send the SRS on a symbol in an UpPTS of at least one of the two special subframes in the radio frame, so that signaling overheads during SRS transmission can be significantly reduced.

In addition, the terminal device is further instructed to send the SRS on the symbol in the UpPTS of the at least one of the two special subframes in the radio frame, so as to avoid frequent carrier switching, and reduce carrier switching overheads.

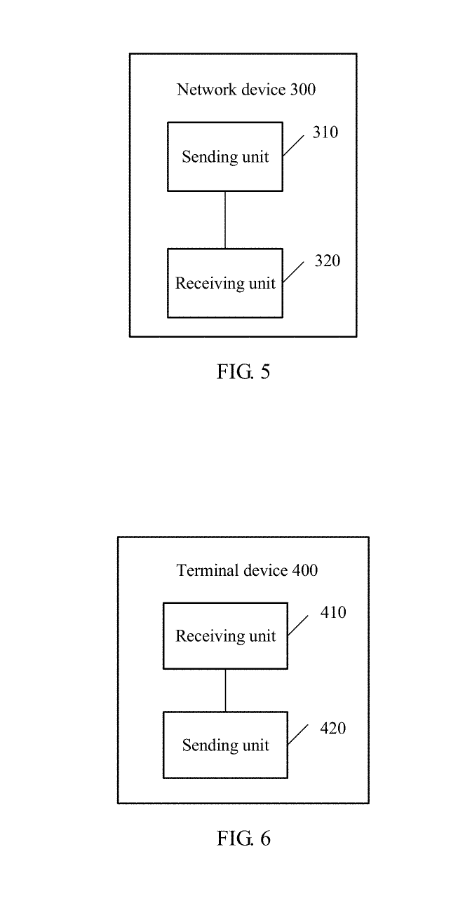

FIG. 5 is a schematic block diagram of a network device 300 according to an embodiment of this application. As shown in FIG. 5, the network device 300 includes a sending unit 310 and a receiving unit 320.

The sending unit 310 is configured to send an instruction message to a terminal device, where the instruction message is used to instruct the terminal device to send an SRS on a second symbol in first symbols, the first symbols are symbols in uplink pilot slots (UpPTSs) of two special subframes in a radio frame, and the second symbol is a symbol in an UpPTS of at least one of the two special subframes. The receiving unit 320 is configured to receive, on the second symbol, the SRS sent by the terminal device.

Optionally, the sending unit 310 is further configured to:

send at least two SRS configurations to the terminal device, where the at least two SRS configurations include at least two SRS configuration indexes I_{SRS}, and the at least two I_{SRS} are corresponding to the first symbols.

Optionally, the symbols in the UpPTSs include two symbol sets, and there is no intersection between the two symbol sets.

The at least two SRS configurations are used to indicate symbols in at least one of the two symbol sets; and the I_{SRS} is used to indicate an SRS subframe offset and an SRS period, and used to determine the symbols in the symbol set.

Optionally, the at least two SRS configurations include a first SRS configuration, a second SRS configuration, and a third SRS configuration. The first SRS configuration includes a first I_{SRS}, the second SRS configuration includes a second I_{SRS}, and the third SRS configuration includes a third I_{SRS}.

The first I_{SRS} is corresponding to a symbol in a first symbol set of the at least two symbol sets.

The second I_{SRS} and the third I_{SRS} are separately corresponding to symbols in a second symbol set of the at least two symbol sets, where a symbol corresponding to the second I_{SRS} is different from a symbol corresponding to the third I_{SRS}.

Optionally, the at least two SRS configurations include a fourth SRS configuration and a fifth SRS configuration. The fourth SRS configuration includes a fourth I_{SRS}, and the fifth SRS configuration includes a fifth I_{SRS}.

The fourth I_{SRS} is corresponding to a symbol in a first symbol set of the at least two symbol sets.

The fifth I_{SRS} is corresponding to a symbol in a second symbol set of the at least two symbol sets.

Optionally, the fifth I_{SRS} is corresponding to four subframe offsets, and the four subframe offsets are corresponding to four symbols in the second symbol set.

Optionally, an SRS trigger type corresponding to the at least two SRS configurations is a first trigger type or a second trigger type.

When the SRS trigger type corresponding to the at least two SRS configurations is the first trigger type, the at least two SRS configurations and the instruction message are used to instruct the terminal device to send the SRS on the second symbol; or

when the SRS type corresponding to the at least two SRS configurations is the second trigger type, the sending unit 310 is further configured to send an SRS request to the terminal device in a subframe n, so as to instruct the terminal device to send the SRS on a second symbol, indicated by the instruction message, in an UpPTS of the first special subframe that meets n+k, where k is an integer greater than or equal to 4.

Optionally, the device 300 is applied to a TDD system.

It should be understood that the foregoing and other operations and/or functions of the units of the network device 300 in this embodiment of this application are separately used to implement corresponding procedures of the network device in the method 200 in FIG. 4. For brevity, details are not described herein again.

FIG. 6 is a schematic block diagram of a terminal device 400 according to an embodiment of this application. As shown in FIG. 6, the terminal device 400 includes a receiving unit 410 and a sending unit 420.

The receiving unit 410 is configured to receive an instruction message sent by a network device, where the instruction message is used to instruct the terminal device to send an SRS on a second symbol in first symbols, the first symbols are symbols in uplink pilot slots (UpPTSs) of two special subframes in a radio frame, and the second symbol is a symbol in an UpPTS of at least one of the two special subframes. The sending unit 420 is configured to send the SRS to the network device on the second symbol.

Optionally, the receiving unit 410 is further configured to receive at least two SRS configurations sent by the network device. The at least two SRS configurations include at least two SRS configuration indexes I_{SRS}, and the at least two I_{SRS} are corresponding to the first symbols, and used to determine the first symbols based on the at least two SRS configurations.

Optionally, the symbols in the UpPTSs include two symbol sets, and there is no intersection between the two symbol sets.

The at least two SRS configurations are used to indicate symbols in at least one of the two symbol sets; and the I_{SRS} is used to indicate an SRS subframe offset and an SRS period, and used to determine the symbols in the symbol set.

Optionally, the at least two SRS configurations include a first SRS configuration, a second SRS configuration, and a third SRS configuration. The first SRS configuration includes a first I_{SRS}, the second SRS configuration includes a second I_{SRS}, and the third SRS configuration includes a third I_{SRS}.

The first I_{SRS} is corresponding to a symbol in a first symbol set of the at least two symbol sets.

The second I_{SRS} and the third I_{SRS} are separately corresponding to symbols in a second symbol set of the at least two symbol sets, where a symbol corresponding to the second I_{SRS} is different from a symbol corresponding to the third I_{SRS}.

Optionally, the at least two SRS configurations include a fourth SRS configuration and a fifth SRS configuration. The fourth SRS configuration includes a fourth I_{SRS}, and the fifth SRS configuration includes a fifth I_{SRS}.

The fourth I_{SRS} is corresponding to a symbol in a first symbol set of the at least two symbol sets.

The fifth I_{SRS} is corresponding to a symbol in a second symbol set of the at least two symbol sets.

Optionally, the fifth I_{SRS} is corresponding to four subframe offsets, and the four subframe offsets are corresponding to four symbols in the second symbol set.

Optionally, an SRS trigger type corresponding to the at least two SRS configurations is a first trigger type or a second trigger type.

When the SRS trigger type corresponding to the at least two SRS configurations is the first trigger type, the at least two SRS configurations and the instruction message are used to instruct to send the SRS to the network device on the second symbol; or

when the SRS type corresponding to the at least two SRS configurations is the second trigger type, the receiving unit 410 is further configured to receive, in a subframe n, an SRS request sent by the network device; and the sending unit 420 is configured to send the SRS on a second symbol, indicated by the instruction message, in an UpPTS of the first special subframe that meets n+k, where k is an integer greater than or equal to 4.

Optionally, the terminal device is applied to a time division duplex (TDD) system.

It should be understood that the foregoing and other operations and/or functions of the units of the terminal device 400 in this embodiment of this application are separately used to implement corresponding procedures of the terminal device in the method 200 in FIG. 4. For brevity, details are not described herein again.

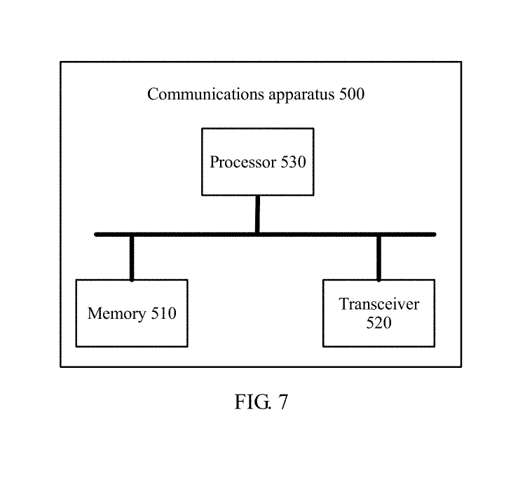

FIG. 7 is a schematic block diagram of a communications apparatus 500 according to an embodiment of this application. The communications apparatus 500 includes:

a memory 510, configured to store a program;

a transceiver 520, configured to communicate with another device; and

a processor 530, configured to execute the program stored in the memory 510.

Optionally, when the code is executed, the processor 530 may implement the operations performed by the terminal device in the method. For brevity, details are not described herein again. In this case, the communications apparatus 500 may be a terminal device.

Optionally, when the code is executed, the processor 530 may implement the operations performed by the network device in the method. For brevity, details are not described herein again. In this case, the communications apparatus 500 may be a network device.

It should be understood that in this embodiment of this application, the processor 530 may be a central processing unit (CPU), or the processor 530 may be another general-purpose processor, a digital signal processor (DSP), an application-specific integrated circuit (ASIC), a field programmable gate array (FPGA) or another programmable logic device, a discrete gate or a transistor logic device, a discrete hardware component, or the like. The general-purpose processor may be a microprocessor, or the processor may be any conventional processor or the like.

The memory 510 may include a read-only memory and a random access memory, and provide an instruction and data for the processor 530. A part of the memory 510 may further include a non-volatile random access memory. For example, the memory 510 may further store information about a device type.

In an implementation process, steps in the foregoing methods can be implemented by using an integrated logic circuit of hardware in the processor 530, or by using instructions in a form of software. The steps of the methods disclosed with reference to the embodiments of this application may be directly performed by a hardware processor, or may be performed by using a combination of hardware in the processor and a software module. The software module may be located in a mature storage medium in the art, such as a random access memory, a flash memory, a read-only memory, a programmable read-only memory, an electrically erasable programmable memory, or a register. The storage medium is located in the memory, and the processor 530 reads information in the memory and performs the steps in the foregoing methods in combination with hardware of the processor. To avoid repetition, details are not described herein again.

It should be understood that sequence numbers of the foregoing processes do not mean execution sequences in various embodiments of this application. The execution sequences of the processes should be determined based on functions and internal logic of the processes, and should not be construed as any limitation on the implementation processes of the embodiments of this application.

A person of ordinary skill in the art may be aware that, with reference to the examples described in the embodiments disclosed in this specification, units and algorithm steps may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that, for convenience and brevity of description, for a detailed working process of the foregoing system, apparatus, and unit, reference may be made to a corresponding process in the foregoing method embodiments, and details are not described herein again.

In the several embodiments provided in this application, it should be understood that the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not performed. In addition, the shown or discussed mutual couplings or direct couplings or communication connections may be implemented by using some interfaces. The indirect couplings or communication connections between the apparatuses or units may be implemented in electrical, mechanical, or other forms.

The units described as separate parts may or may not be physically separated, and parts shown as units may or may not be physical units, may be located in one position, or may be distributed on a plurality of network units. Some or all of the units may be selected according to actual requirements to achieve the objectives of the solutions of the embodiments.

In addition, functional units in the embodiments of this application may be integrated into one processing unit, or each of the units may exist alone physically, or two or more units may be integrated into one unit.

When functions are implemented in a form of a software functional unit and sold or used as an independent product, the functions may be stored in a computer readable storage medium. Based on such an understanding, the technical solutions of this application essentially, or the part contributing to the prior art, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in the embodiments of this application. The storage medium includes any medium that can store program code, such as a USB flash drive, a removable hard disk, a read-only memory (ROM), a random access memory (RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A method for receiving a sounding reference signal (SRS), the method comprising:
sending, by a network device, at least two SRS configurations to a terminal device, wherein the at least two SRS configurations comprise at least two SRS configuration indexes, wherein the at least two SRS configuration indexes correspond to first symbols, and wherein the first symbols are symbols in uplink slots in a radio frame;
sending, by the network device, an instruction message to the terminal device, wherein the instruction message is used to instruct the terminal device to send an SRS on a second symbol in the first symbols; and
receiving, by the network device on the second symbol, the SRS sent by the terminal device.

2. The method according to claim 1, wherein each of the at least two SRS configuration indexes indicates an SRS subframe offset and an SRS period.

3. The method according to claim 2, wherein an SRS trigger type corresponding to the at least two SRS configurations is a first trigger type or a second trigger type; and
wherein the SRS trigger type corresponding to the at least two SRS configurations is the first trigger type, and the at least two SRS configurations and the instruction message are used to instruct the terminal device to send the SRS on the second symbol.

4. The method according to claim 1, wherein the network device is part of a time division duplex (TDD) system.

5. The method according to claim 1,
wherein the at least two SRS configurations comprise a first SRS configuration, a second SRS configuration, and a third SRS configuration, the first SRS configuration comprises a first configuration index (first I_{SRS}), the second SRS configuration comprises a second configuration index (second I_{SRS}), and the third SRS configuration comprises a third configuration index (third I_{SRS});
wherein the first I_{SRS} corresponds to a symbol in a first symbol set of at least two symbol sets; and
wherein the second I_{SRS} and the third I_{SRS} separately correspond to symbols in a second symbol set of the at least two symbol sets, wherein a symbol corresponding to the second I_{SRS} is different from a symbol corresponding to the third I_{SRS}.

6. A method for transmitting a sounding reference signal (SRS), comprising:
receiving, by an apparatus, at least two SRS configurations from a network device, wherein the at least two SRS configurations comprise at least two SRS configuration indexes, wherein the at least two SRS configuration indexes correspond to first symbols, and wherein the first symbols are symbols in uplink slots in a radio frame;
receiving, by the apparatus, an instruction message from the network device, wherein the instruction message is used to instruct the apparatus to send an SRS on a second symbol in the first symbols; and
sending, by the apparatus, on the second symbol, the SRS to the network device.

7. The method according to claim 6, wherein each of the at least two SRS configuration indexes indicates an SRS subframe offset and an SRS period.

8. The method according to 7, wherein an SRS trigger type corresponding to the at least two SRS configurations is a first trigger type or a second trigger type; and
wherein the SRS trigger type corresponding to the at least two SRS configurations is the first trigger type, and the at least two SRS configurations and the instruction message are used to instruct the apparatus to send the SRS on the second symbol.

9. The method according to claim 6, wherein the apparatus is part of a time division duplex (TDD) system.

10. The method according to claim 6,
wherein the at least two SRS configurations comprise a first SRS configuration, a second SRS configuration, and a third SRS configuration, the first SRS configuration comprises a first configuration index (first I_{SRS}), the second SRS configuration comprises a second configuration index (second I_{SRS}), and the third SRS configuration comprises a third configuration index (third I_{SRS});
wherein the first I_{SRS} corresponds to a symbol in a first symbol set of at least two symbol sets; and
wherein the second I_{SRS} and the third I_{SRS} separately correspond to symbols in a second symbol set of the at least two symbol sets, wherein a symbol corresponding to the second I_{SRS} is different from a symbol corresponding to the third I_{SRS}.

11. An apparatus, comprising:
at least one processor;
a transceiver; and
a non-transitory computer-readable storage medium coupled to the at least one processor and storing programming instructions for execution by the at least one processor, wherein the programming instructions instruct the at least one processor to control the transceiver perform the steps of:
receiving at least two SRS configurations from a network device, wherein the at least two SRS configurations comprise at least two SRS configuration indexes, wherein the at least two SRS configuration indexes correspond to first symbols, and wherein the first symbols are symbols in uplink slots in a radio frame;
receiving an instruction message from the network device, wherein the instruction message is used to instruct the apparatus to send an SRS on a second symbol in the first symbols; and
sending, on the second symbol, the SRS to the network device.

12. The apparatus according to claim 11, wherein each of the at least two SRS configuration indexes indicates an SRS subframe offset and an SRS period.

13. The apparatus according to 12, wherein an SRS trigger type corresponding to the at least two SRS configurations is a first trigger type or a second trigger type; and
wherein the SRS trigger type corresponding to the at least two SRS configurations is the first trigger type, and the at least two SRS configurations and the instruction message are used to instruct the apparatus to send the SRS on the second symbol.

14. The apparatus according to claim 11, wherein the apparatus is part of a time division duplex (TDD) system.

15. The apparatus according to claim 11,
wherein the at least two SRS configurations comprise a first SRS configuration, a second SRS configuration, and a third SRS configuration, the first SRS configuration comprises a first configuration index (first I_{SRS}), the second SRS configuration comprises a second configuration index (second I_{SRS}), and the third SRS configuration comprises a third configuration index (third I_{SRS});
wherein the first I_{SRS} corresponds to a symbol in a first symbol set of at least two symbol sets; and
wherein the second I_{SRS} and the third I_{SRS} separately correspond to symbols in a second symbol set of the at least two symbol sets, wherein a symbol corresponding to the second I_{SRS} is different from a symbol corresponding to the third I_{SRS}.

16. The method according to claim 2, wherein an SRS trigger type corresponding to the at least two SRS configurations is a first trigger type or a second trigger type, and wherein the SRS trigger type corresponding to the at least two SRS configurations is the second trigger type, the method further comprising:
sending an SRS request to the terminal device in a subframe n, wherein the SRS request instructs the terminal device to send the SRS on the second symbol, indicated by the instruction message, in a first uplink subframe that meets n+k, wherein k is an integer greater than or equal to 4.

17. The method according to 7, wherein an SRS trigger type corresponding to the at least two SRS configurations is a first trigger type or a second trigger type, and wherein the SRS trigger type corresponding to the at least two SRS configurations is the second trigger type, the method further comprising:
receiving, by the apparatus, an SRS request in a subframe n, wherein the SRS request instructs the apparatus to send the SRS on the second symbol, indicated by the instruction message, in a first uplink subframe that meets n+k, wherein k is an integer greater than or equal to 4.

18. The apparatus according to 12, wherein an SRS trigger type corresponding to the at least two SRS configurations is a first trigger type or a second trigger type, and wherein the SRS trigger type corresponding to the at least two SRS configurations is the second trigger type, the method further comprising:
receiving an SRS request in a subframe n, wherein the SRS request instructs the apparatus to send the SRS on the second symbol, indicated by the instruction message, in a first uplink subframe that meets n+k, wherein k is an integer greater than or equal to 4.
